(19) United States
(12) Patent Application Publication
(10) Pub. No.: US 2025/0009592 A1
(43) Pub. Date: Jan. 9, 2025

(54) Bathing Device for Individuals with Low to No Mobility

(71) Applicants: JUNE MOORE, LOS ANGELES, CA (US); RACHEL JENICE MOORE, LOS ANGLES, CA (US)

(72) Inventors: JUNE MOORE, LOS ANGELES, CA (US); RACHEL JENICE MOORE, LOS ANGLES, CA (US)

(21) Appl. No.: 18/766,284

(22) Filed: Jul. 8, 2024

Related U.S. Application Data
(60) Provisional application No. 63/512,557, filed on Jul. 7, 2023.

(51) Int. Cl. A61H 9/00

(52) U.S. Cl. CPC A61H 9/0028; A61H 2201/0157

(57) ABSTRACT

The bathing device is an apparatus intended for facilitating bathing for an individual with low mobility or those who are bed-bound is disclosed. To accomplish this, the apparatus includes a bathing unit, a water pumping system, and a water disposal system. The water pumping system may include a removable shower hose and nozzle fluidly coupled to a water pump to receive the water, which is then dispensed through a shower head to clean the patient. An air pump that inflates a boundary portion of the bathing mat is disposed along a periphery of the bathing mat to ensure water does not spill over. Further, a plurality of tributaries integrated on the mat direct the waterflow. Furthermore, a wastewater bag that collects used wastewater from a horizontal reservoir on the mat may be easily disposed of, and the wastewater bag may be removed and sanitized for future use.

### FIELD OF THE INVENTION

The present invention relates generally to a bathing device. More specifically, the present invention is a bathing device for facilitating bathing for an individual with low to no mobility.

### BACKGROUND OF THE INVENTION

The field of baths, closets, sinks, and spittoons is technologically important to several industries, business organizations, and/or individuals. In particular, the use of baths, closets, sinks, and spittoons is prevalent for bathing for an individual.

Bathing does far more than minimize body odors. It can help to avoid skin breakdown and infections, prevents UTIs, promotes blood circulation, respiration, and elimination, helps maintain joint mobility, and reduce the occurrence of bed sores. Cleaning and bathing are essential for elderly people and people of any age who have conditions that may leave them vulnerable to skin irritations, bed sores, or unsanitary conditions while promoting a sense of cleanness and normalcy for people who experience diminished mobility, incontinence, an inability to stand (bed bound), and newborn babies. Existing techniques for facilitating bathing for an individual are deficient with regard to several aspects. Current technologies are large and cumbersome and do not effectively assist caregivers with bed bath cleaning and the bathing process when dealing with clients with low mobility. Furthermore, current technologies do not use running water and a shower nozzle to simulate shower-like conditions, thereby promoting relaxation and increasing overall sanitation and hygienic conditions.

Therefore, there is a need for improved methods and systems for facilitating bathing for an individual that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

According to some embodiments, an apparatus for facilitating bathing for an individual with low to no mobility is disclosed. Accordingly, the apparatus may include a water pumping mechanism comprised in a water bag (or clean water bag). Further, the water pumping mechanism may include a water pump comprising a rechargeable power source chargeable with a USB charger. Further, the apparatus may include the water bag filled with water to clean the patient thoroughly. Further, the apparatus may include the removable shower hose and nozzle fluidly coupled to the water pump to receive the water, which is then dispensed through a shower head to clean the patient. Further, the apparatus may include a bathing mat (or hygiene mat). Further, an external (or outside) layer of the bathing mat may include a layer of soft, smooth plastic, while an internal layer of the bathing mat may include soft perforated plastic comprising vertical perforations that serve as tributaries to direct water flow. Further, the parameters of the bathing mat may include high density closed cell foam to protect against water spillage. Further, to provide a second level of protection against water spillage, the bathing mat may include an air pump that inflates a boundary portion of the bathing mat (or mat) disposed along a periphery of the bathing mat to ensure water does not spill over. Further, the air pump may include a power source rechargeable by an external source by using a USB port. Further, an interior flat surface of the mat is perforated to direct water flow. Further, a horizontal tributary at the bottom of the mat forms a reservoir that collects the wastewater. Further, the horizontal reservoir may include a mesh filter (or mesh) covering the reservoir that collects debris and hair. The mesh filter may extend the length of the mat and cover the interior flat surface of the mat including the reservoir that collect water. The mesh may be removable for easy cleaning and sanitizing. Further, the bathing mat may include a suction mechanism that pulls water from the horizontal reservoir through a detachable tube into a wastewater bag. Further, the apparatus may include the wastewater bag that collects used wastewater from the horizontal reservoir into the wastewater bag, where it can be easily disposed of, and the wastewater bag may be removed and sanitized for future use. Further, the apparatus may include a carrying case comprising a shoulder strap and specifically designed compartments to hold each component neatly. Further, the apparatus may include a power switch electrically coupled with the air pump. Further, the power switch may be configured for switching the air pump between an off state and an on state.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

FIG. 1 is a schematic representation of the present invention according to a preferred embodiment of the present invention.

FIG. 2 is a top view of an extension mat lying flat, according to the present invention.

FIG. 3 is a top view of the extension mat, wherein the water guards are upright.

FIG. 4 is a top view of the present invention, wherein the extension mat is attached to the bathing unit, according to the present invention.

FIG. 5 is an illustration of a privacy gown according to the present invention.

FIG. 6 is an illustration of a carrying case that can hold the present invention.

### DETAIL DESCRIPTIONS OF THE INVENTION

All illustrations of the drawings are for the purpose of describing selected versions of the present invention and are not intended to limit the scope of the present invention.

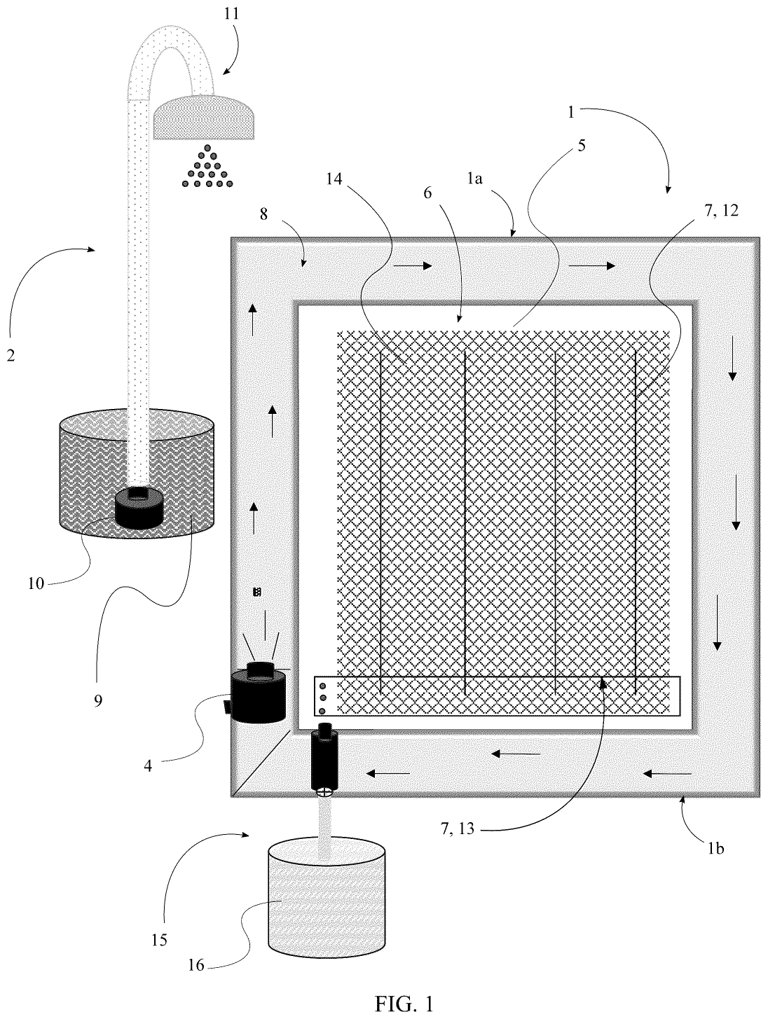

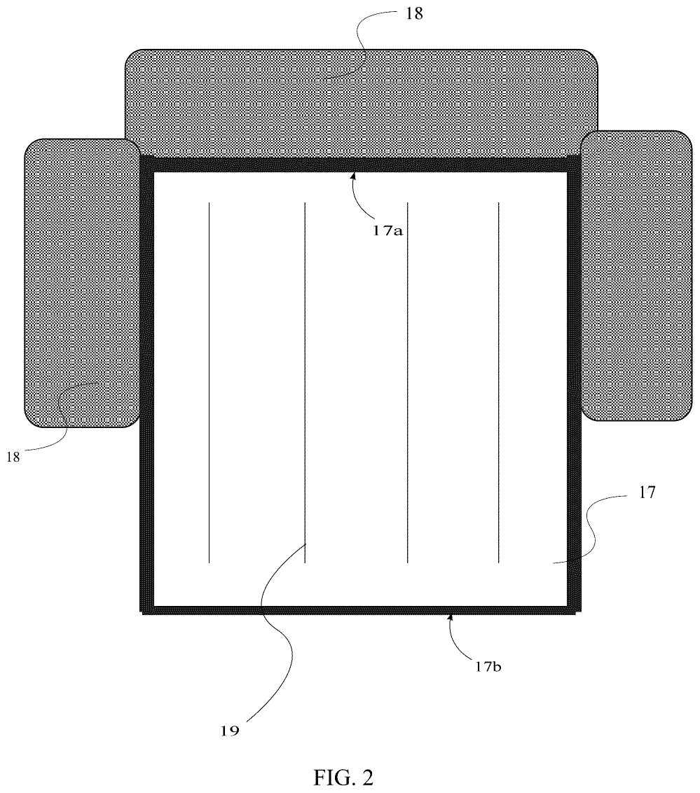

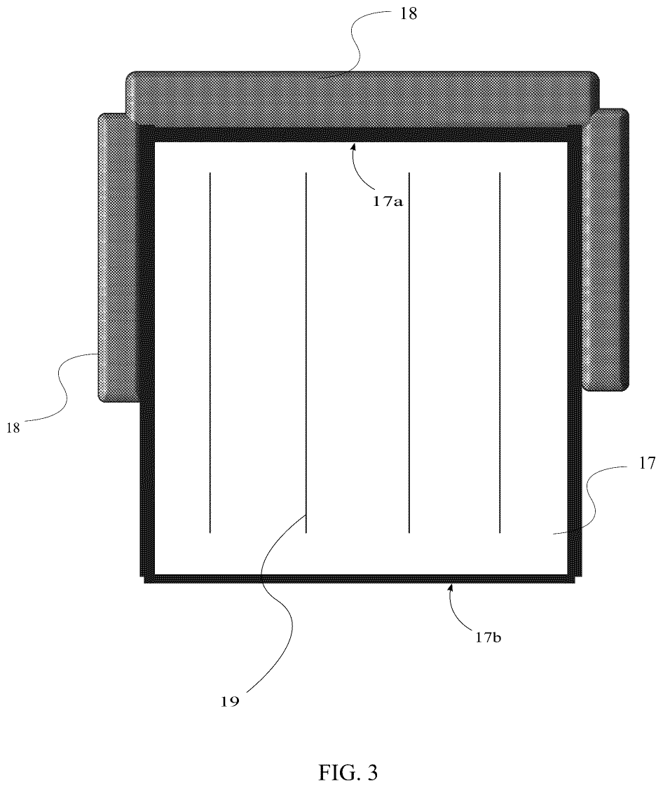

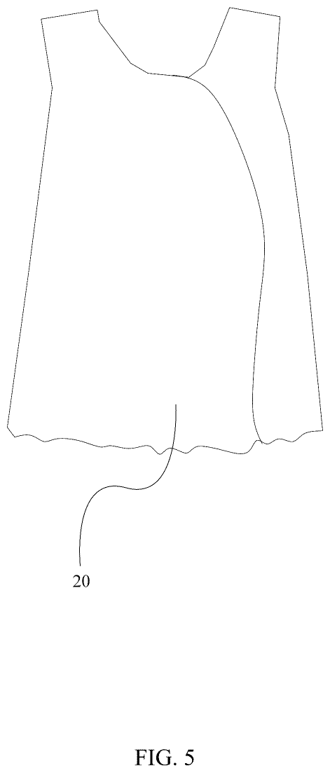

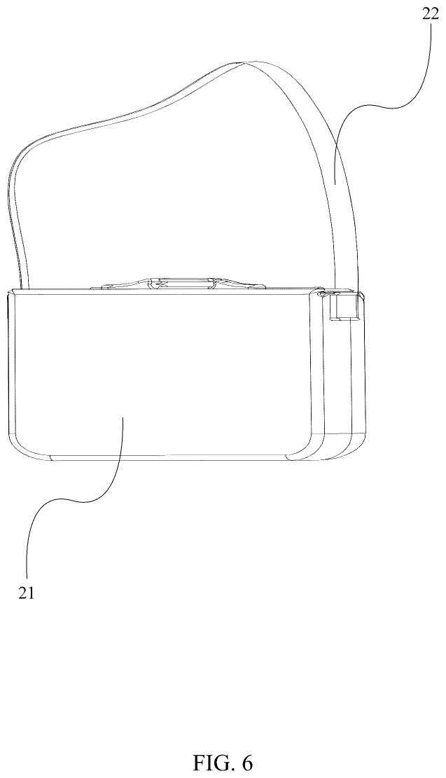

In reference to FIG. 1 through FIG. 6, the present invention is a bathing device for an individual with low mobility or those who are bed-bound.

The following description is in reference to FIG. 1 through FIG. 6. According to a preferred embodiment, the present invention comprises a bathing unit 1, a water pumping system 2, a water disposal system 3, and an air pump 4. Preferably, the bathing unit 1 comprises a bathing mat 5, a first end 1a, a second end 1b, an interior region 6, a plurality of tributaries 7, and an inflatable region 8. In the preferred embodiment, the first end 1a constitutes the top end of the bathing unit 1 and the second end 1b constitutes a bottom end of the bathing unit 1. The interior region 6 is an upper surface of the bathing mat 5. In other words, the first end 1a is positioned opposite to the second end 1b across the bathing unit 1. The plurality of tributaries 7 is integrated within the interior region 6. More specifically, an external (or outside) layer of the bathing mat 5 may include a layer of soft, smooth plastic, while an internal layer of the bathing mat may include soft perforated plastic comprising vertical perforations that serve as tributaries to direct water flow. Further, the perimeters of the bathing mat 5 may include high density closed cell foam to protect against water spillage. Further, to provide a second level of protection against water spillage, the present invention includes the air pump 4 that inflates a boundary portion of the bathing mat 5 (or mat) disposed along a periphery of the bathing mat 5 (to approximately 4″) to ensure water does not spill over. As seen in FIG. 1, the inflatable region 8 is positioned perimetrically around the interior region 6. To enable inflating of the inflatable region 8, the air pump 4 is mounted within the inflatable region 8 of the bathing unit 1. To further enable with the operation of the air pump 4, the present invention may comprise a power source, (which is preferably a rechargeable battery), a switch or any HID (human interface device) that can activate the air pump, a charging port (such as a USB port) for enabling charging of the power source, etc. However, it should be noted that any such electronic and electric components (such as wires, cable, wireless operating module, knobs, switches, etc.) that are known to one of ordinary skill in the art that may be used for the smooth functioning of the present invention, fall under the scope of the present invention. Thus, the air pump 4 is operably integrated to the inflatable region 8, wherein operating the air pump 4 governs inflation and deflation of the inflatable region 8.

According to the preferred embodiment, the bathing experience is accomplished while the client is safely resting in bed. Accordingly, the bathing mat 5 is a pad rolled out underneath the patient while the patient is lying in bed on their side. This process is similar to that of using disposal under pads for patients who suffer from incontinence, baby diaper changing, or puppy potty training. Once the pad or hygiene pad is in place, the perimeters of the bathing mat 5 are inflated, the water pumping system 2 is attached and is ready to be used for thoroughly and safely cleaning the patient. Accordingly, a width of the bathing mat 5 measures 36″ (the width of a standard hospital bed), and a length of the bathing mat 5 ranges from 32″ to 36″ (when an average adult is lying on the pad, the approximate reach may be from the middle of the person's back down to the person's knees). However, the bathing mat 5 may comprise any other material, dimensions, components, arrangement of components etc., that are known to one of ordinary skill in the art, as long as the intents of the present invention are not altered.

To accomplish bathing, the water pumping system 2 is detachably mounted adjacent to the first end 1a of the bathing unit 1. Preferably, the water pumping system 2 is operably connected to the bathing unit 1, wherein operating the water pumping system 2 enables to dispense water along the interior region of the bathing mat 5. Further, the water disposal system 3 helps with disposing of the wastewater after bathing the patient. To that end, the water disposal system 3 is in fluid communication with the bathing unit 1. More specifically, the water disposal system 3 is operably connected to the bathing unit 1, wherein operating the water disposal system 3 enables disposal of wastewater from the bathing unit 1. To help with this, the water disposal system is mounted adjacent to the second end 1b of the bathing unit 1.

A more detailed description of the present invention follows.

According to the preferred embodiment, and as seen in FIG. 1, the water pumping system 2 comprises a first water bag 9, a water pump 10, and a water delivery system 11. Further, the water pumping system 2 may include a rechargeable power source chargeable with a USB charger. The power source provides the electrical power needed for operating the water pump 10. The first water bag 9 is the water bag filled with clean water to clean the patient thoroughly. Further, the water in the first water bag 9 may be warm. The water pump 10 is mounted within the first water bag 9, or in other words, the water pump 10 may be immersed in the clean water so as to pump clean, warm water. Thus, the water pump 10 is operably coupled between the first water bag 9 and the water delivery system 11, wherein operating the water pump 10 transfers water from the first water bag 9 into the water delivery system 11. Further, the water delivery system 11 is operably coupled to the bathing unit 1, wherein operating the water delivery system 11 governs dispensing of water into the interior region 6 of the bathing unit 1. In the preferred embodiment, the water delivery system 11 is a shower hose with a nozzle. Thus, the present invention includes the removable shower hose and nozzle fluidly coupled to the water pump 10 to receive the water, which is then dispensed through a shower head to clean the patient. However, any other water dispensing system 11 that is known to one of ordinary skill in the art may be used for dispensing water on the patient and the bathing mat 5.

According to the preferred embodiment, an internal layer of the bathing mat 5 may include soft perforated plastic comprising vertical perforations that serve as tributaries to direct water flow. Further, a horizontal tributary at the bottom of the mat forms a reservoir that collects the wastewater. Thus, the plurality of tributaries 7 comprises a plurality of vertical tributaries 12 and a horizontal tributary 13. Preferably, the plurality of vertical tributaries 12 extends vertically from the first end 1a of the bathing unit 1 towards the second end 1b of the bathing unit 1, and the horizontal tributary 13 extends horizontally adjacent to the second end 1b of the bathing unit 1. As seen in FIG. 1, the horizontal tributary 13 is laterally offset from the inflatable region 8. Furthermore, the plurality of vertical tributaries 12 is in fluid communication with the horizontal tributary 13, such that all the water flowing along the interior region 6 may be collected by the horizontal tributary 13 during and after the bathing process.

Continuing with the preferred embodiment, the present invention comprises a mesh filter 14, wherein the mesh filter 14 is mounted along the interior region 6. This is so that the mesh filter 14 may collect debris and hair before sending the waster water into the water disposal system 3. In other words, the mesh filter 14 is operably coupled between the plurality of tributaries 7 and the water disposal system 3, wherein the mesh filter 14 collects debris from the wastewater flowing down the plurality of tributaries 7. Furthermore, the mesh filter 14 may be removable for easy cleaning and sanitizing.

According to the preferred embodiment, the water disposal system 3 comprises a water suction system 15, and a second water bag 16. Preferably, the water suction system 15 is in fluid communication with the plurality of tributaries 7, so that the water suction system 15 pulls water from the horizontal tributary 13 through a detachable tube 17 into a second water bag 16. In other words, the water suction system 15 is operably connected between the second water bag 16 and the plurality of tributaries 7, wherein wastewater collected by the plurality of tributaries 7 adjacent the second end 1b of the bathing unit 1, is transported to the second water bag 16 by the water suction system 15. More specifically, the apparatus may include the second water bag 16 (wastewater bag) so as to that collect used wastewater from the horizontal reservoir or horizontal tributary 13 into the wastewater bag, where it can be easily disposed of, and the wastewater bag may be removed and sanitized for future use. To that end, the second water bag 16 is detachably mounted adjacent to the second end 1b of the bathing unit 1.

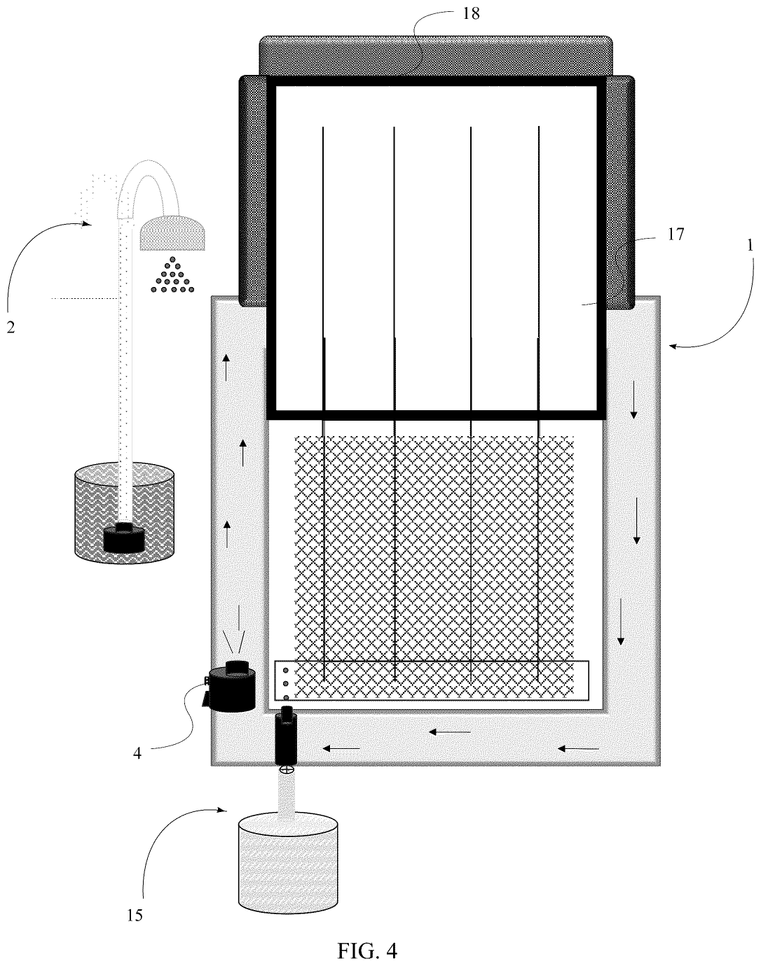

In some embodiment, the present invention comprises an extension mat 17, wherein the extension mat 17 is detachably connected to the first end 1a of the bathing unit 1. The extension mat 17 may be used in instances when the patient's shoulders can be elevated. The extension mat 17 cradles the patient's head and shoulders with fold-out side panels. Further, the extension mat 17 extends downward and then overlaps the top of the inflated bathing mat. Accordingly, as seen in FIG. 4, the extension mat 17 comprises a third end 17a, a fourth end 17b, a plurality of guards 18, and a plurality of perforations 19. Preferably, the third end 17a is positioned opposite to the fourth end 17b across the extension mat 17. In other words, the third end 17a constitutes a top end of the extension mat 17, and the fourth end 17b constitutes a bottom end of the extension mat 17. The plurality of guards 18 is mounted terminally along a plurality of edges that are positioned adjacent to the third end 17a of the extension mat 17. In the preferred embodiment, the perimeters of the extension mat 17 do not inflate, however, the plurality of guards 18 comprises panels on three sides (top and both sides) of the extension mat 17 that extend upward to a 90-degree angle. The plurality of guards 18 serves to contain water and direct water downward and onto the primary bathing mat. In the preferred embodiment, the plurality of guards 18 are high density foam walls. However, the extension mat 17 and the plurality of guards 19 may comprise any other material that is known to one of ordinary skill in the art, as long as the intents of the present invention are not altered. The extension mat 17 may allow the patient to be showered/cleaned from the head down while still lying in bed. To accomplish this, the fourth end 17b of the extension mat 17 slides flush into the interior region 6 of the bathing unit 1, adjacent to the first end 1a of the bathing unit 1. More specifically, the extension mat 17 extends downward and then overlaps the top of the inflated bathing mat 5. Further, the plurality of perforations 19 is in fluid communication with the plurality of tributaries 7, so that there is a direction for the flow of water along both mats.

Continuing with the preferred embodiment, the present invention may comprise a privacy gown 20, wherein the privacy gown 20 is detachably connected to the bathing unit 1. Preferably, the privacy gown 20 has an elastic bottom with a drawstring top with an opening (covered by a flap) that extends the entire length of the front of the gown. Many adults and young adults are apprehensive about being unclothed and bath. In these cases, the specially made privacy gown 20 is used to minimize exposure while still allowing for the application of a cleaning agent and water. Further, the present invention comprises a carrying case 21 with a shoulder strap 22 that has specifically designed compartments to fit each component. In other words, the shoulder strap 22 is laterally mounted onto the carrying case 21, and the bathing unit 1, the water pumping system 2, the water disposal system 3, the air pump 4, and the extension mat 17 are foldable and fit within the carrying case 21.

Although the invention has been explained in relation to its preferred embodiment, it is to be understood that many other possible modifications and variations can be made without departing from the spirit and scope of the invention as hereinafter claimed.

What is claimed is:

1. A bathing device, comprising:
a bathing unit;
a water pumping system;
a water disposal system;
an air pump;
the bathing unit comprising a first end, a second end, a bathing mat, an interior region, a plurality of tributaries, and an inflatable region;
the first end being positioned opposite to the second end across the bathing unit;
the interior region constituting an upper surface of the bathing mat;
the plurality of tributaries being integrated within the interior region;
the inflatable region being positioned perimetrically around the interior region;
the water pumping system being detachably mounted adjacent to the first end of the bathing unit;
the water pumping system being operably connected to the bathing unit, wherein operating the water pumping system enables to dispense water along the interior region of the bathing unit;
the water disposal system being in fluid communication with the bathing unit;
the water disposal system being operably connected to the bathing unit, wherein operating the water disposal system enables disposal of wastewater from the bathing unit;
the water disposal system being mounted adjacent to the second end of the bathing unit;
the air pump being mounted within the inflatable region of the bathing unit; and
the air pump being operably integrated to the inflatable region, wherein operating the air pump governs inflation and deflation of the inflatable region.

2. The bathing device of claim 1, further comprising:
the water pumping system comprising a first water bag, a water pump, and a water delivery system;
the water pump being mounted within the first water bag;
the water pump being operably coupled between the first water bag and the water delivery system, wherein operating the water pump transfers water from the first water bag into the water delivery system; and
the water delivery system being operably coupled to the bathing unit, wherein operating the water delivery system governs dispensing of water into the interior region of the bathing unit.

3. The bathing device of claim 2, wherein the water delivery system is a shower hose with a nozzle.

4. The bathing device of claim 1, further comprising:
the plurality of tributaries comprising a plurality of vertical tributaries and a horizontal tributary;
the plurality of vertical tributaries extending vertically from the first end of the bathing unit towards the second end of the bathing unit;
the horizontal tributary extending horizontally adjacent to the second end of the bathing unit;
the horizontal tributary being laterally offset from the inflatable region; and
the plurality of vertical tributaries being in fluid communication with the horizontal tributary.

5. The bathing device of claim 1, comprising:
a mesh filter;
the mesh filter being mounted along the interior region; and
the mesh filter being operably coupled between the plurality of tributaries and the water disposal system, wherein the mesh filter collects debris from the wastewater flowing down the plurality of tributaries.

6. The bathing device of claim 1, further comprising:
the water disposal system comprising a water suction system, and a second water bag;
the water suction system being in fluid communication with the plurality of tributaries; and
the water suction system being operably connected between the second water bag and the plurality of tributaries, wherein wastewater collected by the plurality of tributaries adjacent the second end of the bathing unit, is transported to the second water bag by the water suction system.

7. The bathing device of claim 6, wherein second water bag is detachably mounted adjacent the second end of the bathing unit.

8. The bathing device of claim 1 further comprising:
an extension mat; and
the extension mat being detachably connected to the first end of the bathing unit.

9. The bathing device of claim 8, further comprising:
the extension mat comprising a third end, a fourth end, a plurality of guards, and a plurality of perforations;
the third end being positioned opposite to the fourth end across the extension mat;
the plurality of guards being mounted terminally around a plurality of second edges, wherein the plurality of second edges is positioned along and adjacent to the third end of the extension mat;
the fourth end of the extension mat sliding flush into the interior region of the bathing unit, adjacent to the first end of the bathing unit; and
the plurality of perforations being in fluid communication with the plurality of tributaries.

10. The bathing device of claim 8, wherein a plurality of guards of the extension mat are high density foam walls.

11. The bathing device of claim 1, comprising:
a privacy gown; and
the privacy gown being detachably connected to the bathing unit.

12. The bathing device of claim 1, comprising:
a carrying case;
a shoulder strap;
the shoulder strap being laterally mounted onto the carrying case; and
the bathing unit, the water pumping system, the water disposal system, the air pump, and the extension mat being foldable and fitting within the carrying case.

13. A bathing device, comprising:
a bathing unit;
a water pumping system;
a water disposal system;
an air pump;
an extension mat;
the bathing unit comprising a first end, a second end, a bathing mat, an interior region, a plurality of tributaries, and an inflatable region;
the first end being positioned opposite to the second end across the bathing unit;
the interior region constituting an upper surface of the bathing mat;
the plurality of tributaries being integrated within the interior region;
the inflatable region being positioned perimetrically around the interior region;
the water pumping system being detachably mounted adjacent to the first end of the bathing unit;
the water pumping system being operably connected to the bathing unit, wherein operating the water pumping system enables to dispense water along the interior region of the bathing unit;
the water disposal system being in fluid communication with the bathing unit;
the water disposal system being operably connected to the bathing unit, wherein operating the water disposal system enables disposal of wastewater from the bathing unit;
the water disposal system being mounted adjacent to the second end of the bathing unit;
the air pump being mounted within the inflatable region of the bathing unit;
the air pump being operably integrated to the inflatable region, wherein operating the air pump governs inflation and deflation of the inflatable region; and
the extension mat being detachably connected to the first end of the bathing unit.

14. The bathing device of claim 13, further comprising:
the water pumping system comprising a first water bag, a water pump, and a water delivery system;
the water pump being mounted within the first water bag;
the water pump being operably coupled between the first water bag and the water delivery system, wherein operating the water pump transfers water from the first water bag into the water delivery system; and
the water delivery system being operably coupled to the bathing unit, wherein operating the water delivery system governs dispensing of water into the interior region of the bathing unit, and wherein the water delivery system is a shower hose with a nozzle.

15. The bathing device of claim 13, further comprising:
the plurality of tributaries comprising a plurality of vertical tributaries and a horizontal tributary;
the plurality of vertical tributaries extending vertically from the first end of the bathing unit towards the second end of the bathing unit;
the horizontal tributary extending horizontally adjacent to the second end of the bathing unit;
the horizontal tributary being laterally offset from the inflatable region; and
the plurality of vertical tributaries being in fluid communication with the horizontal tributary.

16. The bathing device of claim 13, comprising:
a mesh filter;
the mesh filter being mounted along the interior region; and
the mesh filter being operably coupled between the plurality of tributaries and the water disposal system, wherein the mesh filter collects debris from the wastewater flowing down the plurality of tributaries.

17. The bathing device of claim 13, further comprising:
the water disposal system comprising a water suction system, and a second water bag;
the water suction system being in fluid communication with the plurality of tributaries; and
the water suction system being operably connected between the second water bag and the plurality of tributaries, wherein wastewater collected by the plurality of tributaries adjacent the second end of the bathing unit, is transported to the second water bag by the water suction system.

18. The bathing device of claim 17, further comprising:
the extension mat comprising a third end, a fourth end, a plurality of guards, and a plurality of perforations;
the third end being positioned opposite to the fourth end across the extension mat;
the plurality of guards being mounted terminally around a plurality of second edges, wherein the plurality of second edges is positioned along and adjacent to the third end of the extension mat;
the fourth end of the extension mat sliding flush into the interior region of the bathing unit, adjacent to the first end of the bathing unit; and
the plurality of perforations being in fluid communication with the plurality of tributaries.

19. The bathing device of claim 13, comprising:
a privacy gown; and
the privacy gown being detachably connected to the bathing unit.

20. The bathing device of claim 13, comprising:
a carrying case;
a shoulder strap;
the shoulder strap being laterally mounted onto the carrying case; and
the bathing unit, the water pumping system, the water disposal system, the air pump, and the extension mat being foldable and fitting within the carrying case.
